(19) United States
(12) Patent Application Publication
(10) Pub. No.: US 2014/0184793 A1
(43) Pub. Date: Jul. 3, 2014

(54) MULTISPECTRAL FLAME DETECTOR

(71) Applicant: HONEYWELL INTERNATIONAL INC., Morristown, NJ (US)

(72) Inventor: Barrett E. Cole, Bloomington, MN (US)

(73) Assignee: Honeywell International Inc., Morristown, NJ (US)

(21) Appl. No.: 13/731,880

(22) Filed: Dec. 31, 2012

(51) Int. Cl. H04N 7/18

(52) U.S. Cl. 348/143

(57) ABSTRACT

A flame detection system including optics positioned to collect radiation from a scene and provide multiple images of the scene, sets of microbolometer pixels, each set receiving one of the multiple images, wherein the images comprise different spectra of the scene, and electronics to receive signals from the different sets of microbolometer pixels and to distinguish a flame in the scene from non-flame sources of radiation.

### BACKGROUND

Detection of flames is important to protect high value assets such as refineries and oil platforms and aircraft hangers. In these situations something more than a simple detector that might result in a high false alarm rate is desired. False alarms can result in costs from lost production in refineries and other processes due to safety protocols that are followed when an alarm is triggered. Typical detectors have individual sensitive detector elements that are either pyro or photoconductors that “see” a wide field of view and record a signal when the in-band radiation reaches a certain level.

Welding, the sun, and heaters are false alarm sources because they also produce significant radiation levels. To discriminate between these false alarm sources, the spectral bands of the detectors are selected to differentiate between a bright black body which has approximately equal banded radiation, and flame CO2 emission which has strong 4.3 μm radiation but weak 4.0 μm and 4.8 μm radiation. Other spectral discrimination methods are also used such as using wide band and narrow band detectors.

False alarms still occur in triple band flame detectors because the three wide field of view detectors are not able to discriminate between a number of sources or sources based on location and size of the sources. To have typical high resolution imaging arrays capable of seeing flames by imaging a wide FOV can be prohibitively expensive for a low cost product and to have three working in each of three bands can be even more expensive requiring three arrays or a filter wheel. Flame detectors have used rotating filters to obtain diverse spectral images of potential flame sources. Such rotating filters are a moving part that can add expense, complexity, and additional failure modes to a flame detector.

### SUMMARY

A flame detection system including optics positioned to collect radiation from a scene and provide multiple images of the scene, sets of microbolometer pixels, each set receiving one of the multiple images, wherein the images comprise different spectra of the scene, and electronics to receive signals from the different sets of microbolometer pixels and to distinguish a flame in the scene from non-flame sources of radiation.

A flame detector including an array of image detection pixels, an image acquisition system coupled to provide images having spatial properties that are the same and different spectral properties to separate portions of the array of image detection pixels, and electronics to process information provided by the array of image detection pixels.

A method including capturing multiple images of a scene in which a flame may occur, filtering each image with a different filter, at least one of which passes a main emission line of an expected type of flame and at least one of which passes a non-main emission, and providing each filtered image to a different set of pixels.

### BRIEF DESCRIPTION OF THE DRAWINGS

FIG. 1 is a block diagram of a flame detector system according to an example embodiment.

FIG. 2 is a block diagram of a multi camera flame detector system showing images for a flame source according to an example embodiment.

FIG. 3 is a block diagram of a multi camera flame detector system showing images for a non-flame source according to an example embodiment.

FIG. 4 is a block diagram of a single bolometer array flame detector system showing images for a flame source according to an example embodiment.

FIG. 5 is a block diagram of a single bolometer array flame detector system showing images for a non-flame source according to an example embodiment.

FIG. 6 is a block diagram of a computer system for processing images and controlling detector systems according to example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software or a combination of software and human implemented procedures in one embodiment. The software may consist of computer executable instructions stored on computer readable media such as memory or other type of storage devices. Further, such functions correspond to modules, which are software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system.

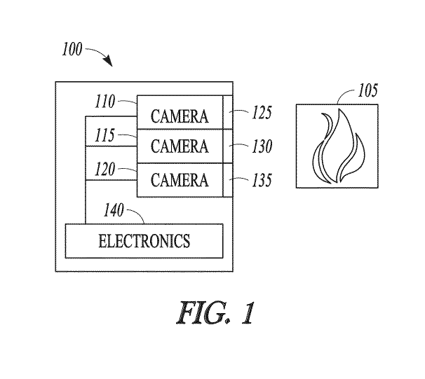

FIG. 1 is a block diagram of an example fire detection system 100 positioned to monitor a target field of view (FOV) that includes a likely flame source 105. In one embodiment, three small size low cost cameras having microbolometer arrays 110, 115, and 120 each have a different spectral band filter 125, 130, and 135 respectively. Each of the cameras with microbolometer arrays is pointed at the same wide FOV. Together, they provide an intermediate cost solution to flame detection and false alarm rejection. In one embodiment, the arrays are small size (60×60) uncooled bolometer arrays that are becoming available at very low cost. With enhanced discrimination based on location within the field of view and in-band and out-of-band spectral information, and perhaps size of the flame based on size of detected image, it is possible to detect flames and also observe bright objects such as the sun, welding, heaters by their spectral and spatial and temporal characteristics with having high resolution. Because of the poor resolution compared to an imager, spatial flicker is difficult to detect, but in some embodiments, intensity flicker may be detectable. The poor resolution is traded for the lower cost and the spectral information, while still maintaining spatial information that is not possible with standard, higher resolution, more expensive, triple infrared (IR) detection systems.

In one embodiment, the three bolometer cameras 110, 115, 120 having a 60×60 pitch can resolve about 5′ at 200′. These cameras have low cost wide FOV chalcogenide lenses like that used on the present NGF DRS MWIR bolometer camera that is 640×480. Because the array is smaller the lenses will also be much smaller and cheaper. The filter 125, 130, 135 with a band width of about 0.1 μm is located in front or alternatively behind each lens. One filter, such as filter 125 for example, may be tuned to CO2 4.4 μm emission. The other filters, such as filters 130 and 135 may be tuned off the emission (4.0 μm and 4.8 μm respectively for example).

Flames 105 are seen mostly with the 4.4 μm filter camera as that is the main emission line of a flame source. Other hot and bright sources have more uniform emission across all three bands. Electronics 140 may be used to process the images and correlate them to whether or not a flame is present. The processing may be as simple as detecting that the emission is uniform across all three bands to prevent alarming. If emissions are detected mostly by the 4.4 μm filter camera, with little emission detected at other frequencies, a flame is most likely present. Appropriate thresholds for detection may be set empirically.

The ability to see where the radiation is coming from in the FOV and the size of the source in pixel count provides significant benefit (over the present single signal solutions) even with poor spatial resolution in discriminating flames from other hot sources.

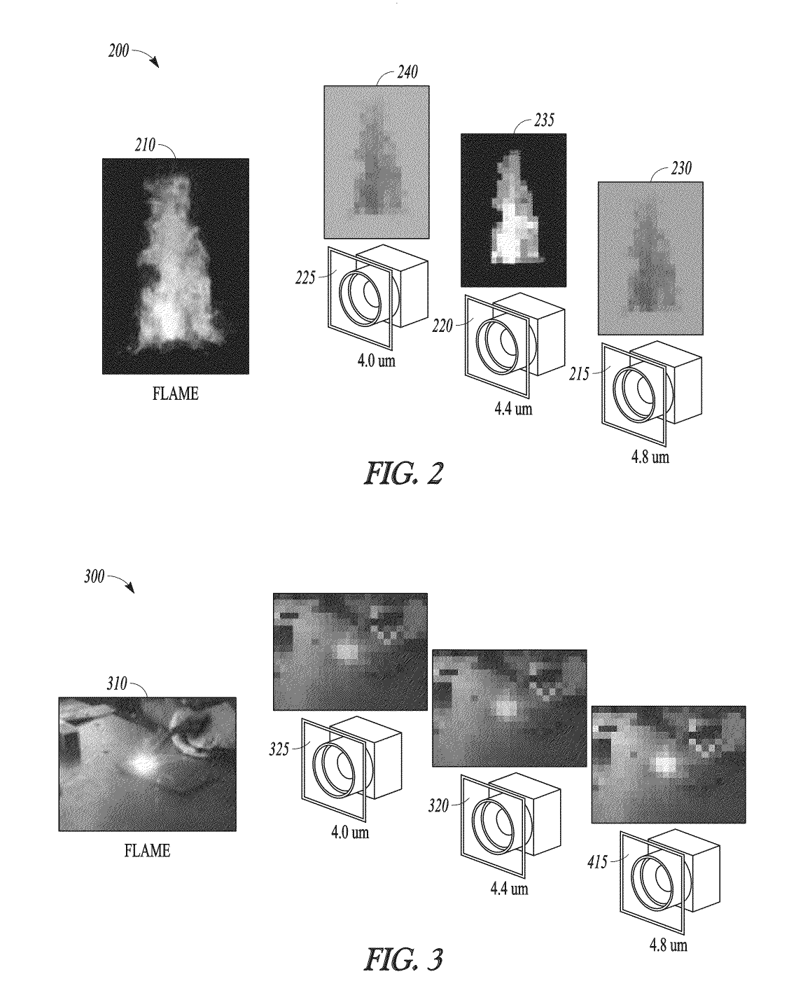

FIG. 2 illustrates a flame detection system 200 in operation to detect a flame 210. Three separate cameras 215, 220, 225 have a similar field of view that includes flame 210. Each camera has a different filter 215, 220, and 220 tuned to allow radiation to reach the cameras at 4.8 μm, 4.4 μm, and 4.0 μm respectively. The cameras each include a low resolution microbolometer array that produces corresponding images shown at 230, 235, and 240 respectively. The intensity of the flame in image 235 is apparent visually. The intensity of the images 230 and 240 of the flame is seen as much lower, resulting in the system 200 detecting the flame.

FIG. 3 illustrates a flame detection system 300 in operation to prevent a false alarm when a welding operation 310 is observed in the field of view. FIGS. 2 and 3 show the differences that would occur in the image of welding and a flame, even for objects of equal brightness. Three separate cameras 315, 320, 325 have a similar field of view that includes welding operation 310. Each camera has a different filter 315, 320, and 320 tuned to allow radiation to reach the cameras at 4.8 μm, 4.4 μm, and 4.0 μm respectively. The cameras each include a low resolution microbolometer array that produces corresponding images shown at 230, 235, and 240 respectively. The intensity of the welding operation in all three images is about the same. Electronics is provided the images, calculates the relative intensities, and determines that no flame is present. Generation of a false alarm is avoided.

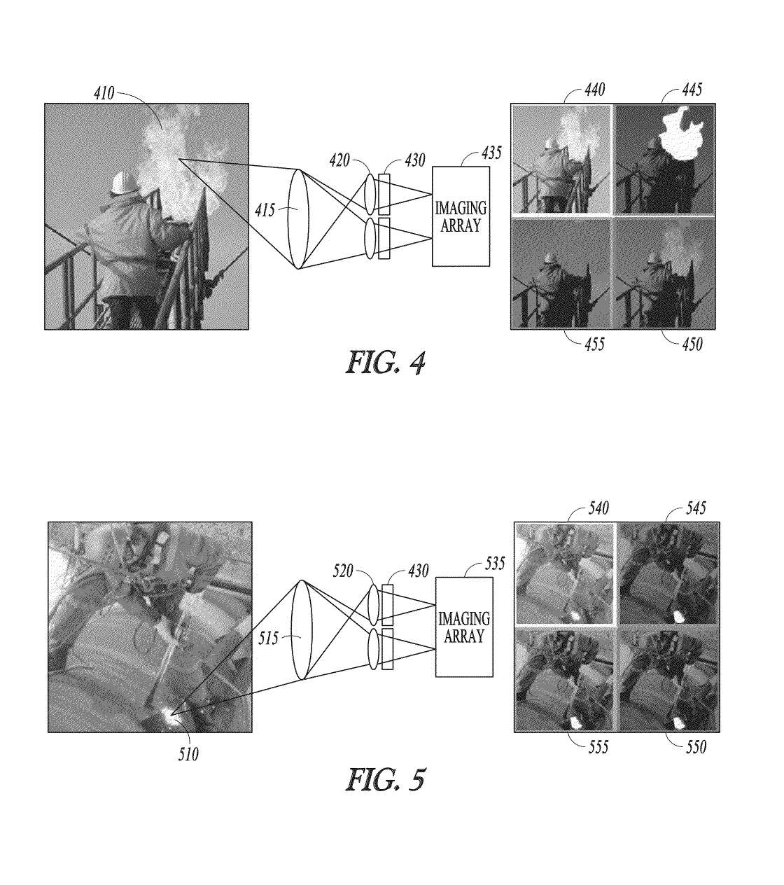

FIGS. 4 and 5 illustrate a single array flame detection system. The figures show the differences that would occur in the image of welding and a flame, even for objects of equal brightness. In a further embodiment, a single imager is used to identify and discriminate between false alarms. The nature of the image can be used to discriminate. A flame is shown at 410 in FIG. 4, and a welding operation is shown at 510 in FIG. 5. A lens system 415, 420 and 515, 520 divides a scene into four equal smaller scenes, each having the same image 410, 510. The four images are passed through a separate filter 430 such that each image is contains different spectral information that is imaged onto a quadrant of an imaging array (eg bolometer) 435, 535.

Each image is transmitted through filters 430 much as is done currently with the multiple detector elements except that an image is produced rather than just a radiance level. In one embodiment, the filters include a 4.0 um, 4.4 um, 4.8 um, and no filter. In further embodiments, one or more of the filters may be the same to provide images for checking to ensure proper operation of the detection system.

The compounded image as shown at 440, 445, 450, 455 for the flame and 540, 545, 550, 555 for the welding operation, has the benefits of using both imagery and spectral content to discriminate between real flames and false alarms. The compounded image also represents the pixel location of each image on the array, which is divided into quadrants in one embodiment. Many different optical systems may be used to provide the four different filtered images onto the array. The detection system provides a further significant improvement on the present imaging detector discrimination method providing spectral signatures as well as spatial signatures.

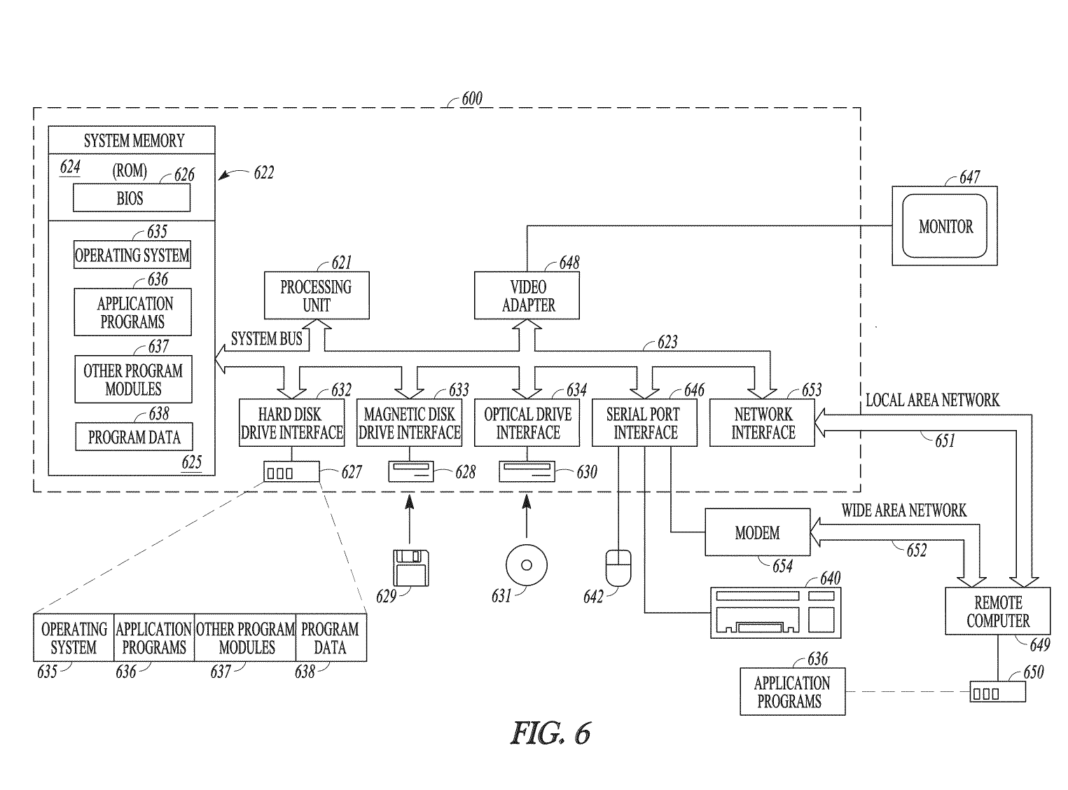

FIG. 6 is a block diagram of a computer system to implement methods according to an example embodiment. In the embodiment shown in FIG. 6, a hardware and operating environment is provided that is applicable to any of the servers and/or remote clients shown in the other Figures.

As shown in FIG. 6, one embodiment of the hardware and operating environment includes a general purpose computing device in the form of a computer 600 (e.g., a personal computer, workstation, or server), including one or more processing units 621, a system memory 622, and a system bus 623 that operatively couples various system components including the system memory 622 to the processing unit 621. There may be only one or there may be more than one processing unit 621, such that the processor of computer 600 comprises a single central-processing unit (CPU), or a plurality of processing units, commonly referred to as a multiprocessor or parallel-processor environment. In various embodiments, computer 600 is a conventional computer, a distributed computer, or any other type of computer.

The system bus 623 can be any of several types of bus structures including a memory bus or memory controller, a peripheral bus, and a local bus using any of a variety of bus architectures. The system memory can also be referred to as simply the memory, and, in some embodiments, includes read-only memory (ROM) 624 and random-access memory (RAM) 625. A basic input/output system (BIOS) program 626, containing the basic routines that help to transfer information between elements within the computer 600, such as during start-up, may be stored in ROM 624. The computer 600 further includes a hard disk drive 627 for reading from and writing to a hard disk, not shown, a magnetic disk drive 628 for reading from or writing to a removable magnetic disk 629, and an optical disk drive 630 for reading from or writing to a removable optical disk 631 such as a CD ROM or other optical media.

The hard disk drive 627, magnetic disk drive 628, and optical disk drive 630 couple with a hard disk drive interface 632, a magnetic disk drive interface 633, and an optical disk drive interface 634, respectively. The drives and their associated computer-readable media provide non volatile storage of computer-readable instructions, data structures, program modules and other data for the computer 600. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 629, optical disk 631, ROM 624, or RAM 625, including an operating system 635, one or more application programs 636, other program modules 637, and program data 638. Programming for implementing one or more processes or method described herein may be resident on any one or number of these computer-readable media.

A user may enter commands and information into computer 600 through input devices such as a keyboard 640 and pointing device 642. Other input devices (not shown) can include a microphone, joystick, game pad, satellite dish, scanner, or the like. These other input devices are often connected to the processing unit 621 through a serial port interface 646 that is coupled to the system bus 623, but can be connected by other interfaces, such as a parallel port, game port, or a universal serial bus (USB). A monitor 647 or other type of display device can also be connected to the system bus 623 via an interface, such as a video adapter 648. The monitor 647 can display a graphical user interface for the user. In addition to the monitor 647, computers typically include other peripheral output devices (not shown), such as speakers and printers.

The computer 600 may operate in a networked environment using logical connections to one or more remote computers or servers, such as remote computer 649. These logical connections are achieved by a communication device coupled to or a part of the computer 600; the invention is not limited to a particular type of communications device. The remote computer 649 can be another computer, a server, a router, a network PC, a client, a peer device or other common network node, and typically includes many or all of the elements described above 110 relative to the computer 600, although only a memory storage device 650 has been illustrated. The logical connections depicted in FIG. 6 include a local area network (LAN) 651 and/or a wide area network (WAN) 652. Such networking environments are commonplace in office networks, enterprise-wide computer networks, intranets and the internet, which are all types of networks.

When used in a LAN-networking environment, the computer 600 is connected to the LAN 651 through a network interface or adapter 653, which is one type of communications device. In some embodiments, when used in a WAN-networking environment, the computer 600 typically includes a modem 654 (another type of communications device) or any other type of communications device, e.g., a wireless transceiver, for establishing communications over the wide-area network 652, such as the internet. The modem 654, which may be internal or external, is connected to the system bus 623 via the serial port interface 646. In a networked environment, program modules depicted relative to the computer 600 can be stored in the remote memory storage device 650 of remote computer, or server 649. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

### EXAMPLES

1. A flame detection system comprising:

optics positioned to collect radiation from a scene and provide multiple images of the scene;

sets of microbolometer pixels, each set receiving one of the multiple images, wherein the images comprise different spectra of the scene; and

electronics to receive signals from the different sets of microbolometer pixels and to distinguish a flame in the scene from non-flame sources of radiation.

2. The flame detection system of example 1 wherein the optics comprise multiple different sets of optics, each having a different filter to provide the different spectra.

3. The flame detection system of example 2 wherein the sets of microbolometer pixels comprise a small array of pixels for each of the different sets of optics.

4. The flame detection system of example 3 wherein the arrays are 60×60 pixels.

5. The flame detection system of any of examples 1-4 wherein the optics comprise a lens to divide the scene into the multiple separate images of the scene.

6. The flame detection system of example 5 and further comprising a different filter for each image to provide the different spectra.

7. The flame detector of any of examples 1-6 wherein the optics include a first set of optics configured to detect a main emission line of a flame of interest.

8. The flame detector of example 7 wherein the optics include a second set of optics configured to detect emissions from at least one different emission line.

9. The flame detector of example 8 wherein the first set of optics includes a filter to pass the main emission line, wherein the main emission line has a wavelength of approximately 4.4 μm.

10. A flame detector comprising:

an array of image detection pixels;

an image acquisition system coupled to provide images having spatial properties that are the same and different spectral properties to separate portions of the array of image detection pixels; and

electronics to process information provided by the array of image detection pixels.

11. The flame detector of example 11 wherein the image acquisition system comprises two different sets of optics.

12. The flame detector of example 11 wherein the different sets of optics include a first set of optics configured to detect a main emission line of a flame of interest.

13. The flame detector of example 12 wherein the different sets of optics include a second set of optics configured to detect emissions from at least one different emission line.

14. The flame detector of example 13 wherein the first set of optics includes a filter to pass the main emission line, wherein the main emission line has a wavelength of approximately 4.4 μm.

15. The flame detector of example 14 wherein the second set of optics includes a filter to pass emissions above or below the main emission line.

16. The flame detector of any of examples 10-15 wherein the image acquisition system comprises a lens configured to direct a single image of interest to the separate portions of the array of image detection pixels.

17. The flame detector of example 16 wherein the image acquisition system comprises multiple filters disposed between the lens and the separate portions of the array of image detection pixels, a first filter configured to pass a main emission line of a flame of interest to a first portion of the array of image detection pixels.

18. The flame detector of example 17 wherein the multiple filters include a second filter configured to pass emissions from at least one different emission line to a second portion of the array of image detection pixels, wherein the main emission line has a wavelength of approximately 4.4 μm.

19. A method comprising:

capturing multiple images of a scene in which a flame may occur;

filtering each image with a different filter, at least one of which passes a main emission line of an expected type of flame and at least one of which passes a non-main emission; and

providing each filtered image to a different set of pixels.

20. The method of example 19 wherein the main emission line has a wavelength of approximately 4.4 μm, and wherein the different set of pixels comprise separate subsets of pixels from a microbolometer array of pixels.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A flame detection system comprising:
optics positioned to collect radiation from a scene and provide multiple images of the scene;
sets of microbolometer pixels, each set receiving one of the multiple images, wherein the images comprise different spectra of the scene; and
electronics to receive signals from the different sets of microbolometer pixels and to distinguish a flame in the scene from non-flame sources of radiation.

2. The flame detection system of claim 1 wherein the optics comprise multiple different sets of optics, each having a different filter to provide the different spectra.

3. The flame detection system of claim 2 wherein the sets of microbolometer pixels comprise a small array of pixels for each of the different sets of optics.

4. The flame detection system of claim 3 wherein the arrays are 60×60 pixels.

5. The flame detection system of claim 1 wherein the optics comprise a lens to divide the scene into the multiple separate images of the scene.

6. The flame detection system of claim 5 and further comprising a different filter for each image to provide the different spectra.

7. The flame detector of claim 1 wherein the optics include a first set of optics configured to detect a main emission line of a flame of interest.

8. The flame detector of claim 7 wherein the optics include a second set of optics configured to detect emissions from at least one different emission line.

9. The flame detector of claim 8 wherein the first set of optics includes a filter to pass the main emission line, wherein the main emission line has a wavelength of approximately 4.4 μm.

10. A flame detector comprising:
an array of image detection pixels;
an image acquisition system coupled to provide images having spatial properties that are the same and different spectral properties to separate portions of the array of image detection pixels; and
electronics to process information provided by the array of image detection pixels.

11. The flame detector of claim 11 wherein the image acquisition system comprises two different sets of optics.

12. The flame detector of claim 11 wherein the different sets of optics include a first set of optics configured to detect a main emission line of a flame of interest.

13. The flame detector of claim 12 wherein the different sets of optics include a second set of optics configured to detect emissions from at least one different emission line.

14. The flame detector of claim 13 wherein the first set of optics includes a filter to pass the main emission line, wherein the main emission line has a wavelength of approximately 4.4 μm.

15. The flame detector of claim 14 wherein the second set of optics includes a filter to pass emissions above or below the main emission line.

16. The flame detector of claim 10 wherein the image acquisition system comprises a lens configured to direct a single image of interest to the separate portions of the array of image detection pixels.

17. The flame detector of claim 16 wherein the image acquisition system comprises multiple filters disposed between the lens and the separate portions of the array of image detection pixels, a first filter configured to pass a main emission line of a flame of interest to a first portion of the array of image detection pixels.

18. The flame detector of claim 17 wherein the multiple filters include a second filter configured to pass emissions from at least one different emission line to a second portion of the array of image detection pixels, wherein the main emission line has a wavelength of approximately 4.4 μm.

19. A method comprising:
capturing multiple images of a scene in which a flame may occur;
filtering each image with a different filter, at least one of which passes a main emission line of an expected type of flame and at least one of which passes a non-main emission; and
providing each filtered image to a different set of pixels.

20. The method of claim 19 wherein the main emission line has a wavelength of approximately 4.4 μm, and wherein the different set of pixels comprise separate subsets of pixels from a microbolometer array of pixels.
